(19) United States
(12) Patent Application Publication
(10) Pub. No.: US 2021/0232149 A1
(43) Pub. Date: Jul. 29, 2021

(54) SYSTEMS AND METHODS FOR PERSISTENT MAPPING OF ENVIRONMENTAL PARAMETERS USING A CENTRALIZED CLOUD SERVER AND A ROBOTIC NETWORK

(71) Applicant: Brain Corporation, San Diego, CA (US)

(72) Inventors: Cody Griffin, San Diego, CA (US); Oleg Sinyavskiy, San Diego, CA (US)

(21) Appl. No.: 17/231,613

(22) Filed: Apr. 15, 2021

Related U.S. Application Data
(63) Continuation of application No. PCT/US19/56476, filed on Oct. 16, 2019.
(60) Provisional application No. 62/746,390, filed on Oct. 16, 2018.

(51) Int. Cl. G05D 1/02

(52) U.S. Cl. CPC G05D 1/0231; H04L 67/12

(57) ABSTRACT

Systems and methods for persistent mapping of environmental parameters using a centralized cloud server and a robotic network are disclosed herein. According to at least one non-limiting exemplary embodiment, a cloud server may utilize a robotic network, comprising a plurality of robots, communicatively coupled to the cloud server to collect data and generate or update a persistent map of a parameter of an environment based on the collected data from the plurality of robots on the robotic network.

### PRIORITY

This application is a continuation of International Patent Application No. PCT/US19/56476 filed Oct. 16, 2019 and claims the benefit of U.S. Provisional patent Application Ser. No. 62/746,390 filed on Oct. 16, 2018 under 35 U.S.C. § 119, the entire disclosure of each are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for persistent mapping of environmental parameters using a centralized cloud server.

### Background

Currently, a robot may generate a map of an environment while navigating through the environment. The map may comprise a plurality of features such as, for example, locations of objects and routes to follow. However, having a robot individually map an environment and store the map within a memory of the robot may be of issue when implementing a plurality of robots within an environment.

Additionally, it may be computationally taxing for each individual robot of a plurality of robots to generate its own map of the environment. Environments may also be dynamic, wherein robots mapping and navigating individually may not respond to dynamic changes to the environment without each individual robot observing and mapping the changes. Further, robots may require temporally accurate maps of many parameters to function optimally including locations of objects, locations of strong/weak Wi-Fi or cellular signal strength, temperature maps (e.g., to avoid extreme temperatures). Temporally accurate of parameters may additionally enhance human workflow in cooperation with robots such as, for example, a heat map of a store guiding an air conditioning maintenance worker to find a faulty vent.

Accordingly, there is a need for systems and methods of persistent mapping of an environment using a centralized cloud server communicatively coupled to a plurality of robots within the environment.

### SUMMARY

The foregoing needs are satisfied by the present disclosure, which provides for, inter alia, systems and methods for persistent mapping of environmental parameters using a centralized cloud server and a robotic network. The systems and methods disclosed herein are directed towards, inter alia, a practical application of distributed cloud computing for generating persistent maps of parameters using data collected from sensors of robots as the robots operate independent of each other and in unison as a network of multiple robots.

Exemplary embodiments described herein have innovative features, no single one of which is indispensable or solely responsible for their desirable attributes. Without limiting the scope of the claims, some of the advantageous features will now be summarized.

According to at least one non-limiting exemplary embodiment, a system comprising a cloud server communicatively coupled to a robot network, comprising a plurality of robots, is disclosed. The cloud server may be configurable to receive sensor data from at least one robot on a robot network communicatively coupled to the cloud server. The cloud server may further be configurable to utilize the received sensor data to generate a plurality of maps of parameters of an environment. These maps may be updated in real-time upon the cloud server receiving new data from one or more robots, wherein these maps updated in real-time may be considered persistent maps. The cloud server may communicate the persistent maps to the at least one robots on the robot network, wherein the robots may utilize the persistent maps to determine and perform tasks within the environment. Additionally, the cloud server may be further configurable to receive an operator query, distribute tasks to at least one robot to collect data, and respond to the operator query based on the data collected by the robots and/or data already stored within a memory of the cloud server.

According to at least one non-limiting exemplary embodiment, a method for generating and updating persistent maps is disclosed. The method may include a cloud server communicating instructions to a robot network, comprising a plurality of robots. The plurality of robots on the robot network may gather data on a plurality of parameters of an environment based on the instruction. The cloud server may then utilize the data from the plurality of robots to generate and/or update a persistent map of a parameter of an environment. The persistent map may be further utilized by the plurality of robots for task selection, route determination, and/or any other task for the robots.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular forms of “a,” “an,” and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a main robot in accordance with some exemplary embodiments of this disclosure.

FIG. 1B is a functional block diagram of a controller or processor or processing device in accordance with some exemplary embodiments of this disclosure.

FIG. 2A is a functional block diagram of a cloud server in accordance with some exemplary embodiments of this disclosure.

FIG. 2B illustrates a robot communicating data to a cloud server to be distributed to a plurality of other robots communicatively coupled to the cloud server, according to an exemplary embodiment.

FIG. 3A illustrates a persistent map of an environment comprising a plurality of objects and routes for robots to follow, according to an exemplary embodiment.

FIG. 3B illustrates a persistent map of an environment comprising a robot, of a plurality of robots within an environment, detecting an object and communicating the detection of the object to a cloud server, according to an exemplary embodiment.

FIG. 3C illustrates a persistent map updated by a cloud server based on localization of an object, according to an exemplary embodiment.

FIG. 4 is a functional block diagram of a system configurable to generate a persistent map, according to an exemplary embodiment.

FIG. 5 is a process flow diagram illustrating a method for a cloud server to update a persistent map based on data collected by at least one robot, according to an exemplary embodiment.

FIG. 6 is a process flow diagram illustrating a method for a robot, communicatively coupled to a cloud server, to receive and execute an instruction from the cloud server, according to an exemplary embodiment.

FIG. 7 is a functional block diagram of a system configurable to receive an operator input to a cloud server and provide an output in response to the operator input, according to an exemplary embodiment.

FIG. 8 is a process flow diagram illustrating a method for a cloud server to receive and process a query from an operator, according to an exemplary embodiment.

FIG. 9A-B illustrate two persistent maps of two parameters generated by a cloud server based on data collected by one or more robots, according to an exemplary embodiment.

FIG. 10A-B illustrates two persistent maps comprising static and moving objects to illustrate a method for a cloud server to determine moving objects within persistent maps, according to an exemplary embodiment.

FIG. 11 illustrates a persistent map in three dimensions in accordance with some exemplary embodiments of persistent maps of this disclosure.

All Figures disclosed herein are © Copyright 2018 Brain Corporation. All rights reserved.

### DETAILED DESCRIPTION

Various aspects of the novel systems and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for persistent mapping of environmental parameters using a centralized cloud server and a robotic network.

As used herein, a robot may include mechanical and/or virtual entities configurable to carry out a complex series of tasks or actions autonomously. In some exemplary embodiments, robots may be machines that are guided and/or instructed by computer programs and/or electronic circuitry. In some exemplary embodiments, robots may include electro-mechanical components that are configurable for navigation, where the robot may move from one location to another. Such robots may include autonomous and/or semi-autonomous cars, floor cleaners, rovers, drones, planes, boats, carts, trams, wheelchairs, industrial equipment, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, a persistent map may include a computer readable map of one or more parameters of an environment comprising a persistent data structure. A parameter of an environment may include heat distributions, Wi-Fi signal strength, object localization, route data, no-go zones, and/or any other parameter of the environment measurable by a sensor of a robot. A persistent data structure may comprise a data structure that always preserves previous versions of itself when modified. A persistent map may be fully persistent (i.e., all versions of the persistent map may be accessed and modified) or partially persistent (i.e., all versions of the persistent map may be accessed but only the current version may be modified). Updates to a persistent map may include generation of a new persistent map of the parameter at a later instance in time, such that prior persistent maps of the parameter at prior instances in time may be parsed by an operator. A persistent map of one or more parameters may include a persistent map of an entire environment or a portion of the environment.

As used herein, a robot network or network of robots may comprise a plurality of robots communicatively coupled to each other and/or coupled to an external cloud server. The plurality of robots may communicate data to other robots on a robot network and to an external cloud server.

As used herein, a cloud server may comprise a server configurable to receive, request, process, and/or return data to robots, humans, and/or other devices. A cloud server may be hosted at the same location as a network of robots communicatively coupled to the cloud server or may be at a separate location.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, processing device, microprocessor, and/or digital processor may include any type of digital processing device such as, without limitation, digital signal processors (“DSPs”), reduced instruction set computers (“RISC”), complex instruction set computer (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) allow robots to detect sunlight in an image received by an imaging camera; (ii) remove areas of an image comprising noise due to sunlight; (iii) enable robots to navigate in more complex regions, such as regions near windows; and (iv) improve the safety of operation of the robots. Other advantages are readily discernable by one having ordinary skill in the art given the contents of the present disclosure.

According to at least one non-limiting exemplary embodiment, a system comprising a cloud server communicatively coupled to a robot network, comprising a plurality of robots, is disclosed. The cloud server may be configurable to receive sensor data from at least one robot on a robot network communicatively coupled to the cloud server. The cloud server may be further configurable to utilize the received sensor data to generate a plurality of maps of parameters of an environment. These maps may be updated in real-time upon the cloud server receiving new data from one or more robots, wherein these maps updated in real-time may be considered persistent maps. The cloud server may communicate the persistent maps to at least one robot on the robot network, wherein the robots may utilize the persistent maps to determine and perform tasks within the environment. Additionally, the cloud server may be further configurable to receive an operator query, distribute tasks to at least one robot to collect data, and respond to the operator query based on the data collected by the robots and/or data already stored within a memory of the cloud server.

According to at least one non-limiting exemplary embodiment, a method for generating and updating persistent maps is disclosed. The method may include a cloud server communicating instructions to a robot network comprising a plurality of robots. The plurality of robots on the robot network may gather data on a plurality of parameters of an environment based on the instruction. The cloud server may then utilize the data from the plurality of robots to generate and/or update a persistent map of a parameter of an environment. The persistent map may be further utilized by the plurality of robots for task selection, route determination, and/or any other task for the robots.

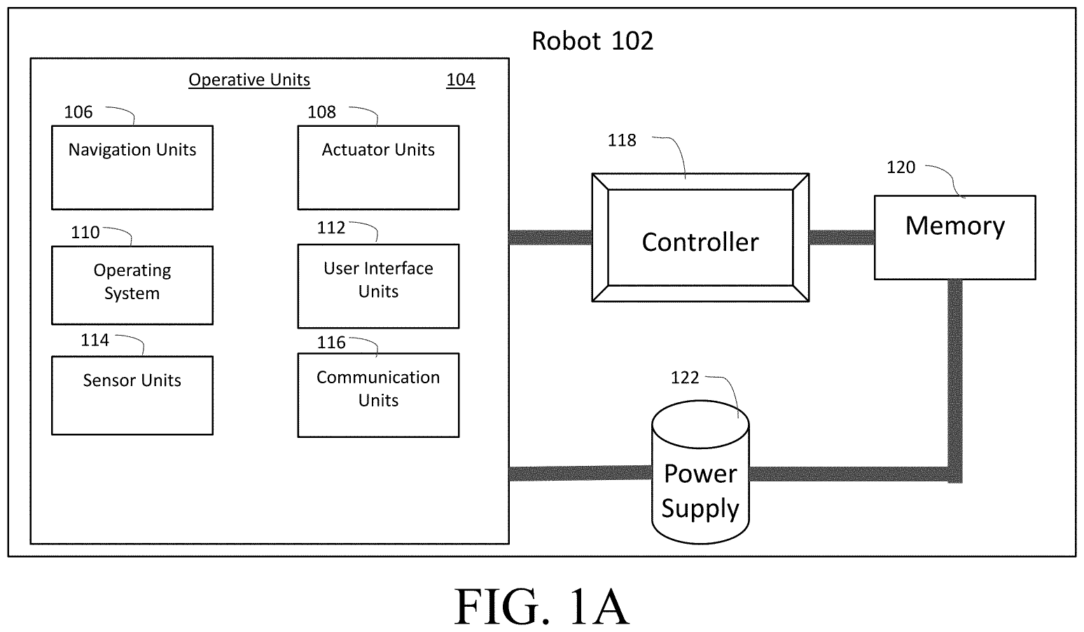

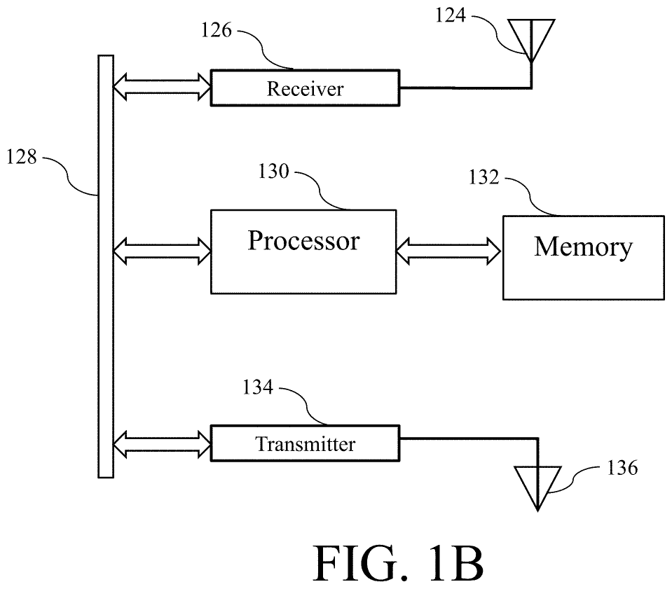

FIG. 1A is a functional block diagram of a robot 102 in accordance with some exemplary embodiments of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors or processing devices (e.g., microprocessors) as shown in FIG. 1B, and other peripherals. As previously mentioned and used herein, processor, microprocessor, and/or digital processor may include any type of digital processing device, such as, without limitation, digital signal processors (“DSPs”), reduced instruction set computers (“RISC”), complex instruction set computer (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die or distributed across multiple components.

Controller 118 may be operatively and/or communicatively coupled to memory 120. Memory 120 may include any type of integrated circuit or other storage device configurable to store digital data, including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configurable to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configurable to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configurable to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors or processing devices. In some embodiments, a single controller (e.g., controller 118) may serve as the various controllers and/or processors or processing devices described. In other embodiments, different controllers and/or processors or processing devices may be used, such as controllers and/or processors or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic. In exemplary embodiments, units of operative units 104 may comprise both computer-implemented instructions executed by a controller and hardcoded logic. Where operative units 104 are implemented in part in software, operative units 104 may include units/modules of code configurable to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configurable to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may actuate the wheels for robot 102 to navigate a route; navigate around obstacles; and rotate cameras and sensors.

Actuator unit 108 may include any system used for actuating, in some cases to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LIDAR”) sensors, radars, lasers, cameras (including video cameras (e.g., red-blue-green (“RBG”) cameras, infrared cameras, three-dimensional (“3D”) cameras, thermal cameras, etc.), time of flight (“TOF”) cameras, structured light cameras, antennas, motion detectors, microphones, and/or any other sensor known in the art. According to exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on measurements. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configurable to determine the odometry of robot 102. For example, sensor units 114 may include proprioceptive sensors, which may comprise sensors, such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement, and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, user interface units 112 may be configurable to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments, user interface units 112 may be positioned on the body of robot 102. According to exemplary embodiments, user interface units 112 may be positioned away from the body of robot 102 but may be communicatively coupled to robot 102 (e.g., via communication units, including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configurable to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configurable to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configurable to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configurable to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configurable to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used here on out, a robot 102, a controller 118, or any other controller, processing device, or robot performing a task illustrated in the figures below comprises a controller executing computer readable instructions stored on a non-transitory computer readable storage apparatus, such as memory 120, as would be appreciated by one skilled in the art.

Next referring to FIG. 1B, the architecture of the specialized controller 118 used in the system shown in FIG. 1A is illustrated according to an exemplary embodiment. As illustrated in FIG. 1B, the specialized computer includes a data bus 128, a receiver 126, a transmitter 134, at least one processing device 130, and a memory 132. The receiver 126, the processing device 130, and the transmitter 134 all communicate with each other via the data bus 128. The processing device 130 is a specialized processing device configurable to execute specialized algorithms. The processing device 130 is configurable to access the memory 132 which stores computer code or instructions in order for the processing device 130 to execute the specialized algorithms. As illustrated in FIG. 1B, memory 132 may comprise some, none, different, or all of the features of memory 124 previously illustrated in FIG. 1A. Memory 124, 132 may include at least one table for storing data therein. The at least one table may be a self-referential table such that data stored in one segment of the table may be related or tied to another segment of the table. For example, data stored in a first row (rᵢ) and first column (cᵢ) may relate to one or more data points stored in one or more different row (r_{z}) and different column (c_{z}), wherein rᵢ, cᵢ, r_{z}, and c_{z} are integral numbers greater than one.

The algorithms executed by the processing device 130 are discussed in further detail below. The receiver 126 as shown in FIG. 1B is configurable to receive input signals 124. The input signals 124 may comprise signals from a plurality of operative units 104 illustrated in FIG. 1A, including, but not limited to, sensor data from sensor units 114, user inputs, motor feedback, external communication signals (e.g., from a remote server), and/or any other signal from an operative unit 104 requiring further processing by the specialized controller 118. The receiver 126 communicates these received signals to the processing device 130 via the data bus 128. As one skilled in the art would appreciate, the data bus 128 is the means of communication between the different components—receiver, processing device, and transmitter—in the specialized controller 118. The processing device 130 executes the algorithms, as discussed below, by accessing specialized computer-readable instructions from the memory 132. Further detailed description as to the processing device 130 executing the specialized algorithms in receiving, processing, and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processing device 130 may communicate output signals to transmitter 134 via data bus 128 as illustrated. The transmitter 134 may be configurable to further communicate the output signals to a plurality of operative units 104 illustrated by signal output 136.

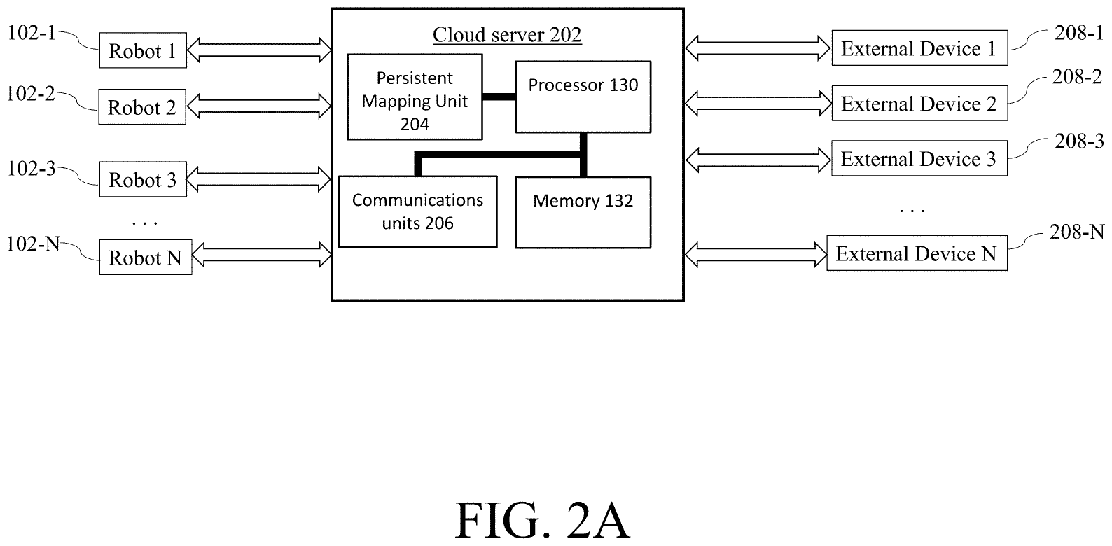

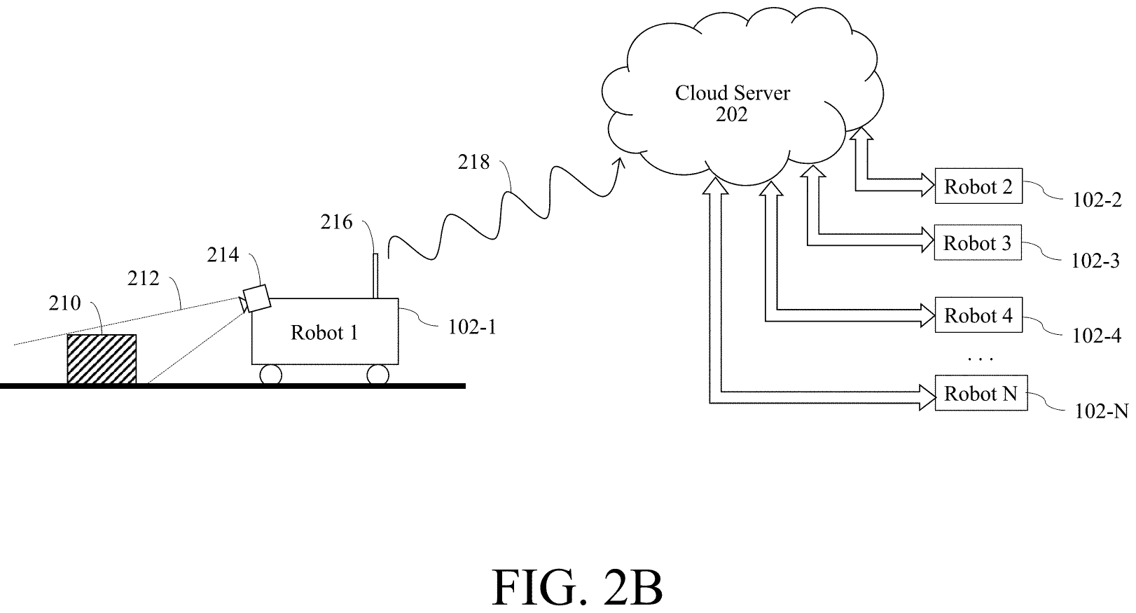

One of ordinary skill in the art would appreciate that the architecture illustrated in FIG. 1B may illustrate an external cloud server architecture configurable to effectuate the control of a robotic apparatus from a remote location. That is, the cloud server may also include a data bus, a receiver, a transmitter, a processing device, and a memory that stores specialized computer readable instructions thereon as illustrated below in FIG. 2A.

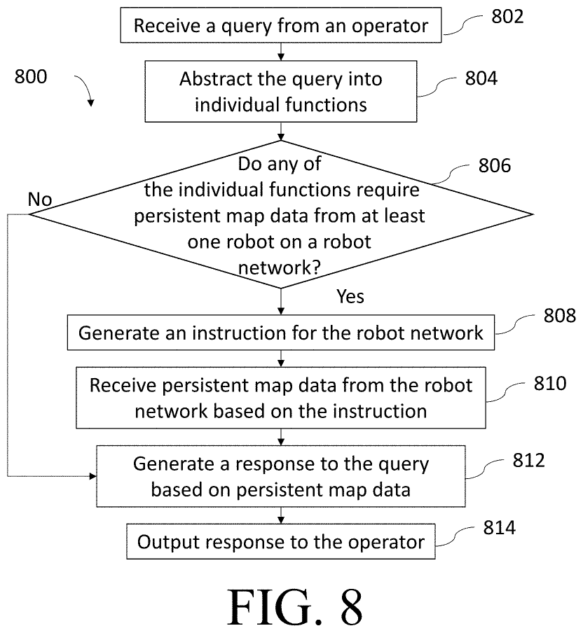

FIG. 2A illustrates a functional block diagram of a cloud server 202 in accordance with some exemplary embodiments of the present disclosure. The cloud server 202 may comprise a substantially similar system architecture as the system architecture illustrated in FIG. 1B above, wherein the cloud server 202 may comprise a processing device 130 configurable to execute computer readable instructions from a memory 132. The cloud server 202 may further comprise a persistent mapping unit 204 configurable to generate persistent maps of parameters of an environment. The parameters may include, but are not limited to, heat distribution, Wi-Fi coverage, locations of no-go zones (i.e., impassible regions), locations of objects and/or other parameter measured or inferred from data from sensor units 114. The persistent mapping unit 204 may utilize sensor data from a plurality of robots 102-1, 102-2, 102-3 . . . 102-N communicatively coupled to the cloud server 202 to generate the persistent maps of parameters. Persistent mapping unit 204 may be a separate operative unit of the cloud server 202 or may be illustrative of the processing device 130 executing computer readable instructions stored in the memory 132 to perform the functions of the persistent mapping unit 204. The cloud server 202 may additionally comprise a communications unit 206 configurable to communicate signals between the cloud server 202 and the plurality of coupled robots 102-1, 102-2, 102-3 . . . 102-N and a plurality of external devices 208-1, 208-2, 208-3 . . . 208-N. The communications unit 206 may comprise a receiver 126 and a transmitter 134, as similarly illustrated above in FIG. 1B. External devices 208 may comprise user interface units, closed-circuit television (CCTV) cameras, internet of things (IoT) devices, and/or other cloud servers 202 at remote locations. The processing device 130 of the cloud server 202 may utilize data from the external devices 208 to, for example, localize a robot 102 on a persistent map based on CCTV data collected by CCTV cameras located within an environment of the persistent map. The processing device 130 may additionally receive a query from an external device 208 or a robot 102 and process the query using a method 800 illustrated below in FIG. 8.

FIG. 2B illustrates a robot 102-1 detecting an object 210 and communicating properties of the object 210 to a cloud server 202, according to an exemplary embodiment. The robot 102-1 may comprise a sensor 214 configurable to detect the object 210, as illustrated by sensor vision lines 212. The sensor 214 may comprise some, none, all, or different features of sensor units 114 illustrated above in FIG. 1A. The sensor 214 may collect data comprising properties of the object 210, including location of the object 210, size of the object 210, image of the object 210, and/or any other parameters of the object 210 detectable by the sensor 214. The robot 102-1, for example, may communicate the collected data of the object 210 to the cloud server 202 using a transceiver 216, as illustrated by a wireless signal 218. Transceiver 216 may be configurable to communicate data from the robot 102-1 to the cloud server 202 and may be part of communications units 116 of the robot 102-1 as illustrated above in FIG. 1A. The robot 102-1, as well as the plurality of other robots 102-2 through 102-N, may comprise or constitute a network of robots 102 communicatively coupled to the cloud server 202. Each of the robots 102 illustrated may further comprise a receiver and transmitter (not shown) configurable to receive and send wireless signals from the cloud server 202.

The cloud server 202 may utilize the data received by the signal 218 from the robot 102-1 to perform a task, calculate a value, localize the object 210, update a persistent map, and/or any other function of which data from the signal 218 may be utilized. For example, a cloud server 202, communicatively coupled to N robots 102, may receive a signal 218 from a robot 102-1, the signal comprising localization data of an object 210 from a sensor 214. The cloud server 202 may utilize the localization data to localize the object 210 on a persistent map. The N robots 102 on the network may then receive the persistent map, comprising the location of the object 210, from the cloud server 202 wherein the N robots 102 may utilize the updated persistent map during future navigation near the object 210, during future route planning, task selection, etc.

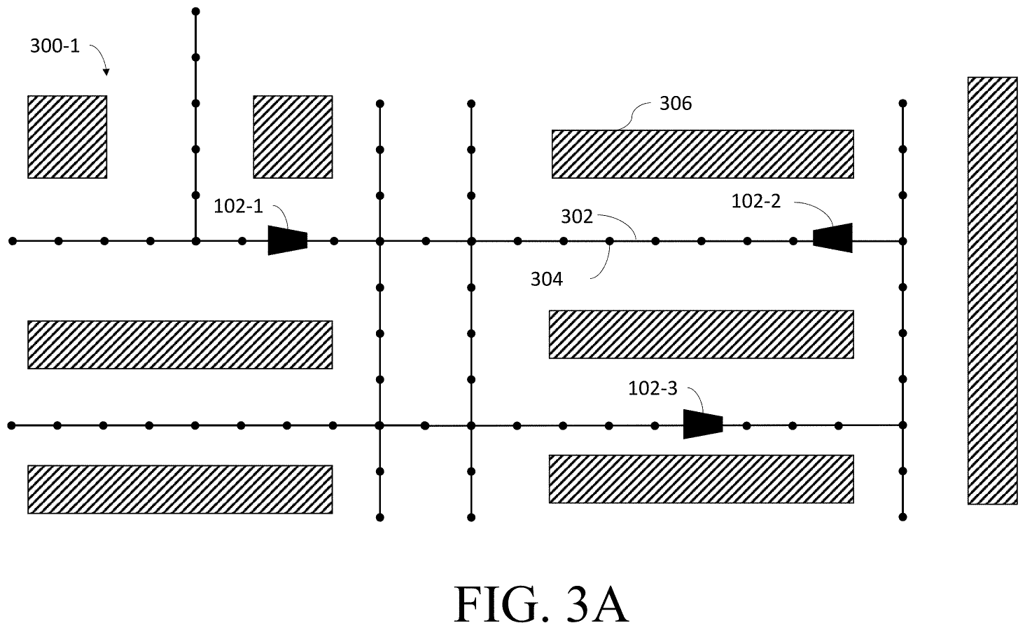

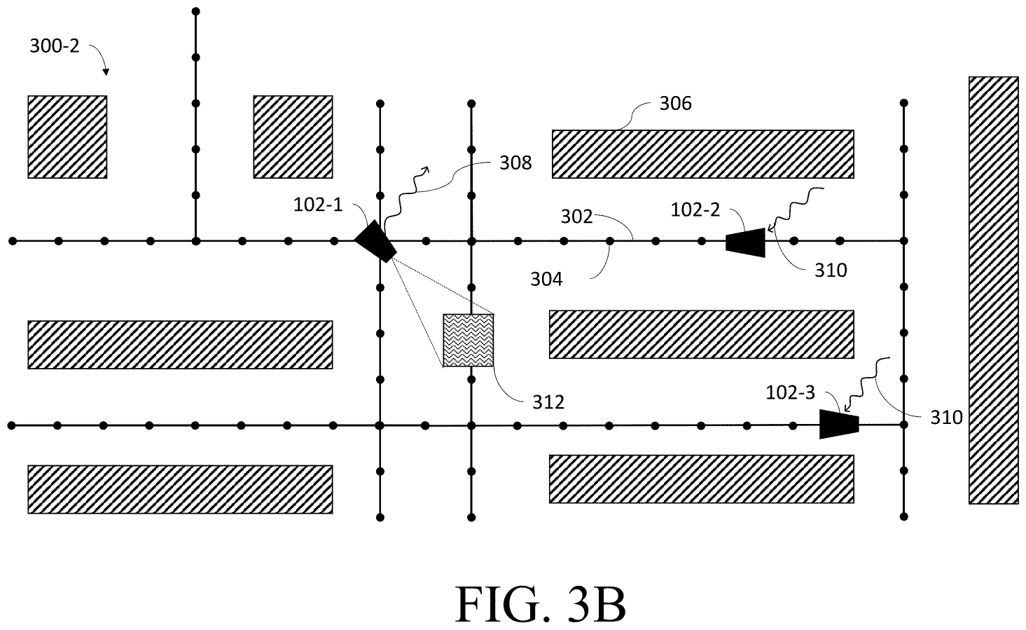

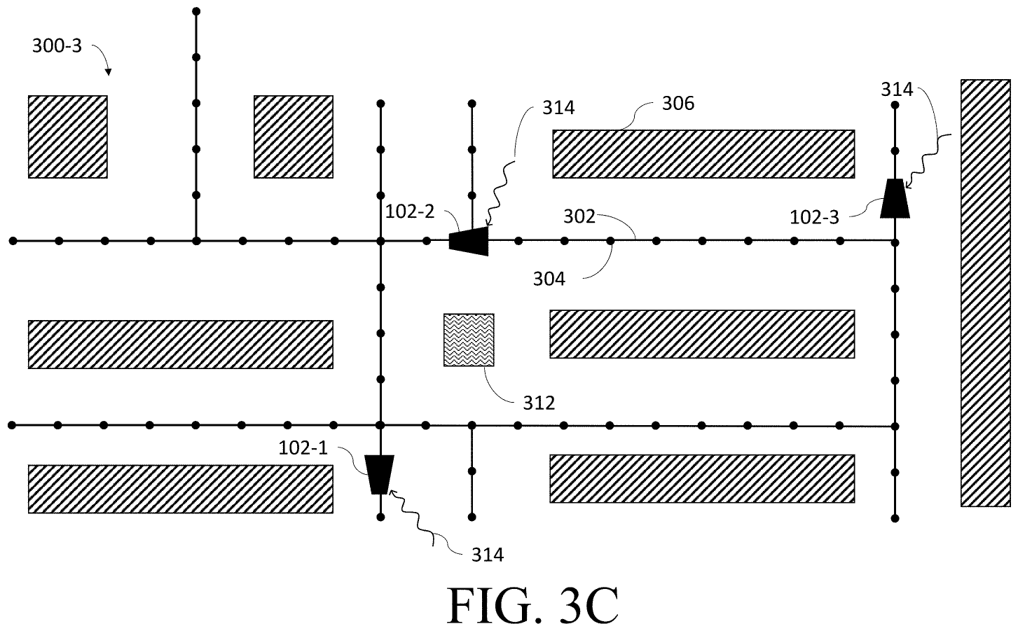

A plurality of parameters of the object 210 may be communicated to the cloud server 202 from the robot 102-1, including, but not limited to, size of object 210, type of object 210, color of object 210, temperature of the object 210, or any other parameter detectable by the sensor 214 of the robot 102-1. Accordingly, the cloud server 202 may communicate these additional parameters to the “N” robots 102 on the network. The additional parameters may be useful to the other “N” robots 102 on the network for task determination. For example, a first robot 102-1 may determine object 210 comprises a pallet, localize the object 210, and communicate the determination to the cloud server 202. The cloud server 202 may then communicate the determination of the pallet and its location to a plurality of other robots 102 on a network communicatively coupled to the cloud server 202, wherein a second robot 102-2, comprising a robotic forklift, may be requested to retrieve the pallet. In the aforementioned example, the cloud server 202 may communicate the determination of the pallet to the N robots 102 by updating a persistent map of an environment of which the N robots 102 operate, as illustrated below in FIG. 3A-C.

According to at least one non-limiting exemplary embodiment, robots 102-1 through 102-N may comprise a plurality of the same robots or may comprise a plurality of different robots configurable to perform different tasks. One skilled in the art would appreciate that the object 210, illustrated by a box, may be illustrative of any object or feature detectable by a sensor 214 of a robot 102-1. For example, the object 210 may comprise a dirty portion of a floor (e.g., a feature of the floor where there is a spill), wherein a cloud server 202 may utilize the determination and location of the dirty portion of the floor to request a cleaning robot 102-2 to clean the dirty portion of the floor.

FIG. 3A illustrates a top view of a persistent map 300-1 of an environment comprising a plurality of robots 102-1 through 102-3 navigating along route 302 at a first instance in time, according to an exemplary embodiment. The persistent map 300-1 may comprise a plurality of mapped objects 306 and a plurality of routes 302 for the robots 102-1 to 102-n to follow. The plurality of routes 302 may further comprise a plurality of state points 304 along the routes 302, the state points 304 comprising state parameters for a robot 102-n at the location of the corresponding state point 304. Parameters of the state points 304 may include, for example, velocity of a robot 102-n at the state point 304, orientation of a robot 102-n at the state point 304, expected sensor data to be observed at the state point 304, and/or any other state parameter of or data to be collected by a robot 102-n at the state point 304. State points 304 may be utilized by the robots 102 to navigate routes 302 accurately. The persistent map 300-1 may be mapped by a cloud server 202, as illustrated above in FIG. 2 (not shown in FIG. 3A-C), based on data and state parameters collected by the plurality of robots 102-n navigating within the environment.

FIG. 3B illustrates a persistent map 300-2 of the same environment illustrated in FIG. 3A at a second instance in time, according to an exemplary embodiment. A robot 102-1 may, at the second instance in time, detect an object 312, or an obstacle, for example, not mapped on the persistent map 300-1 at the previous first instance in time. Accordingly, the robot 102-1 may send a signal 308 to a cloud server 202, the signal comprising parameters of the object 312 (e.g., size, location, color, etc.). The cloud server 202, upon receiving the signal 308, may localize the object 312 on the persistent map 300-2 at the second instance in time. That is, the signal 308 transmitted by robot 102-1 includes information pertaining to the object 312 (i.e., size, color, orientation, location, etc.). The cloud server 202 may further communicate the updated persistent map 300-2 to the other robots 102-2 and 102-3 on the network via signal 310.

According to at least one non-limiting exemplary embodiment, the signal 310 received (i.e., the incoming signal) by the two robots 102-2 and 102-3 may comprise different signals if the two robots 102-2 and 102-3 comprise different robots. For example, the received signal 310 for robot 102-2 may comprise a task to be performed on the newly mapped object 312, such as retrieving the object 312 if the robot 102-2 is configurable or capable to do so, whereas the received signal 310 for the robot 102-3 may simply comprise a localization of the object 312 on the persistent map 300-2 if the robot 102-3 is not configurable to perform a task on the object 312. Thereby, making the robot 102-3 only aware of the location of the object 312 in the environment.

As illustrated in FIG. 3B, a portion of the mapped routes 302 may be blocked by the object 312 thereby causing the cloud server 202 to reroute the robots 102-n on the network accordingly, as illustrated next in FIG. 3C. FIG. 3C illustrates a persistent map 300-3 of the same environment illustrated in FIG. 3A-B at a third instance in time, according to an exemplary embodiment. As illustrated on the persistent map 300-3, some route segments of the routes 302 and state points 304 have been dynamically removed in real-time due to the position of the object 312 on the persistent map 300-2 overlapping with the mapped routes 302. Accordingly, the cloud server 202 may determine the segments dynamically removed in real-time, and corresponding state points along the removed segments, and may further communicate the removal of the segments to the robots 102-n on the network via signals 314 (i.e., the incoming signals from server). The robots 102-n on the network may determine new routes utilizing the persistent map 300-3, which is an updated map, of the environment based on the remaining routes 302 during navigation near the object 312.

According to at least one non-limiting exemplary embodiment, a robot 102 on the network may receive a different persistent map 300-3 (i.e., the updated persistent map) comprising a route 302 near object 312 for the robot 102 to follow in order to perform a task on the object. For example, if object 312 is a pallet, then robot 102-2 is a robotic forklift, for example. A persistent map 300-3 received by the robot 102-2 may comprise a unique route to follow to retrieve the pallet, wherein other robots 102-1 and 102-3 may receive a persistent map 300-3 not comprising the unique route near the pallet if the robots 102-1 and 102-3 are not configurable to perform a task on the pallet.

As illustrated in the above FIG. 3A-C, a persistent map 300 of an environment may provide a plurality of robots 102 on a robot network with real-time data of a surrounding environment based on data collected by the robots 102 on the robot network. The real-time update of the persistent map 300 may greatly enhance the ability of each individual robot 102 to plan routes more efficiently. Additionally, a cloud server 202 receiving real-time data from a plurality of robots 102 on the network may further enhance the efficiency of each of the individual robots 102, of the plurality of robots 102 on the robot network, and the route planning undertaken by each of the individual robots, by enabling the cloud server 202 to delegate specific tasks to individual robots 102.

For example, a robot 102-2, illustrated above in FIG. 3A-C, may be configurable to retrieve the object 312. Without the use of a centralized cloud server 202 collecting data from a distributed network of robots 102, the robot 102-2 may not retrieve the object 312 until the robot 102-2 navigates nearby and detects the object 312. The use of distributed data gathering from the plurality of robots 102 by the cloud server 202 may further enhance the accuracy of the generated persistent map 300 as the cloud server 202 may utilize data from the plurality of robots 102 on the network to verify the data from each robot while generating the persistent map 300. A plurality of other advantages may be appreciated by one skilled in the art with respect to the use of a persistent map 300, and other persistent maps of other parameters (i.e., other than localization parameters), for a distributed network of robots 102.

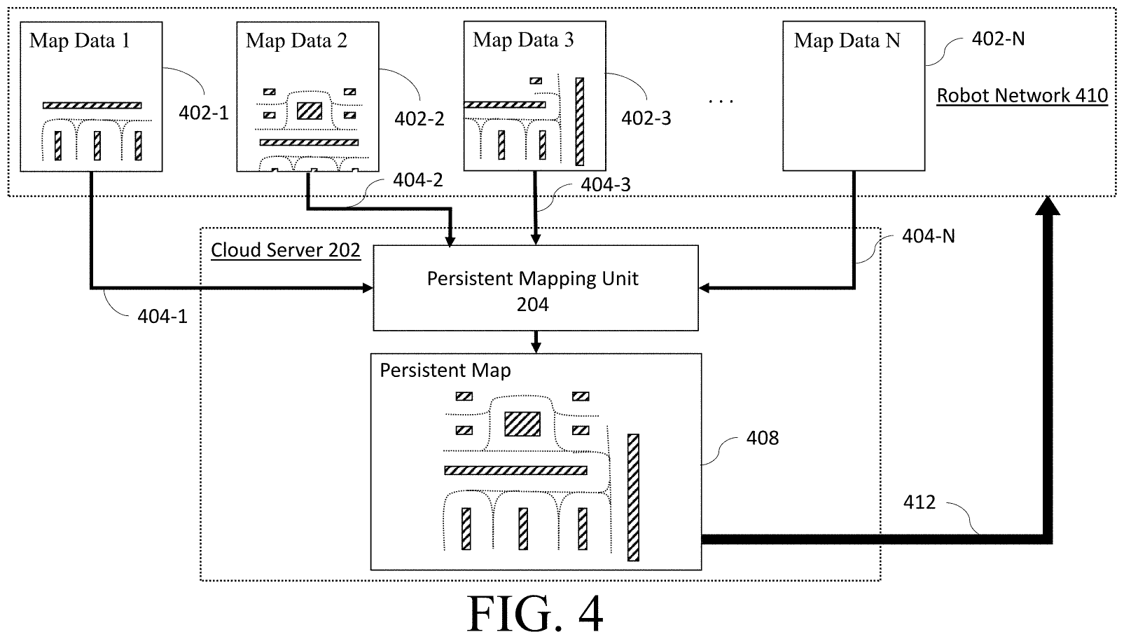

FIG. 4 illustrates a functional block diagram of a system configurable to receive map data 402-1, 402-2 . . . 402-N from a plurality of robots 102 on a robot network 410 and utilize a persistent mapping unit 204 to generate a persistent map 408, according to an exemplary embodiment. Each respective map data 402 block (402-1 to 402-N) may be illustrative of data generated, at least in part, from sensor units 114 of a corresponding robot 102, wherein there may be N robots 102 collecting N map data 402 blocks as illustrated N being an integer number. In some embodiments, each map data 402 block may be received by one robot 102 over a period of time, e.g., during sequential execution of N routes. The map data 402 may comprise mapped portions of the environment to be pieced together to form a persistent map 408 by the persistent mapping unit 204. The map data 402-n from a corresponding robot 102-n may be sent to a persistent mapping unit 204 via a corresponding wireless connections 404-n, wherein index N may correspond to a total number of robots on the robot network 410 and index n may correspond to an arbitrary robot 102, map data 402 block, or connection 404.

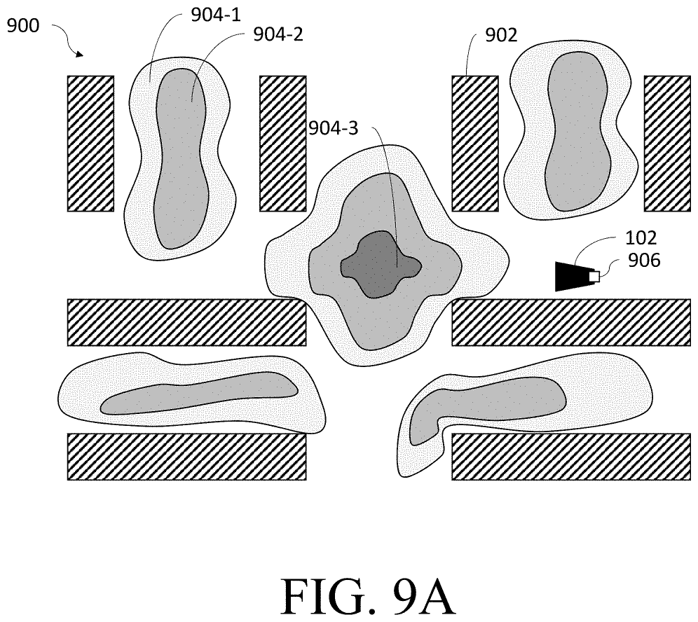

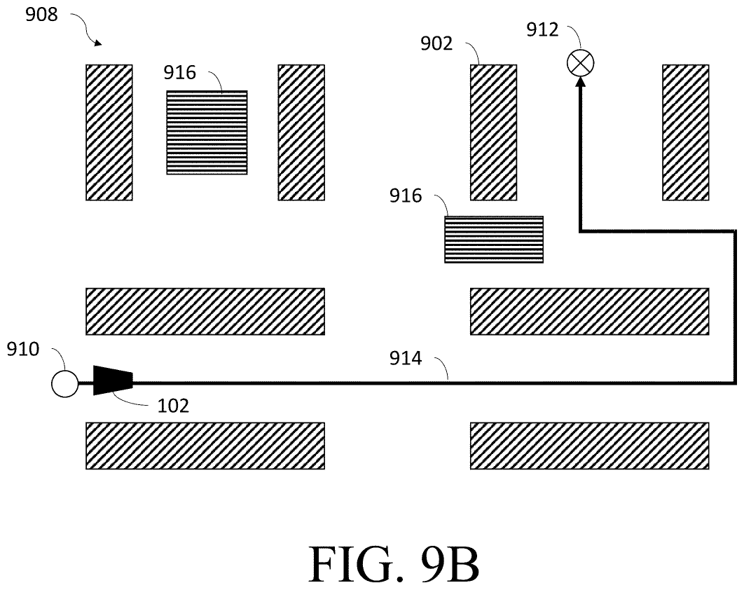

The persistent mapping unit 204 may be configurable to combine the map data 402 from the N robots 102 on the network to generate a persistent map 408 of the environment. The persistent mapping unit 204 may be a portion of persistent mapping unit 204 or illustrative of a processing device 130 of a cloud network 202 executing instructions stored in a memory 132, as illustrated above in FIG. 2A, to perform the functions of the persistent mapping unit 204. The persistent mapping unit 204 may utilize the received map data 402 to generate the persistent map 408 based on, at least in part, localization of an object within two or more maps data 402 blocks or localization of a robot 102 which generated a corresponding map data 402 block. The persistent mapping unit 204 may be further configurable to generate possible routes for the N robots 102 on the network to follow based on, at least in part, routes taken by the individual robots 102 during mapping of the environment. Additional routes may be generated to fill in regions on the persistent map 408 comprising no known or previously navigated routes or may be generated at a later time by the processing device 130 of the cloud network 202 for a robot 102 on the robot network 410 to perform a task. The persistent mapping unit 204 may be further configurable to update the persistent map 408 based on new mapping data received by the N robots 102 on the network at later instances in time. The persistent map 408 may be communicated from the cloud server 202 to the robot network 410 via a wireless connection 412 to be used by the N robots 102 on the robot network 410 for navigation, localization of objects by other robots 102, knowledge of environmental parameters (e.g., no-go zones as illustrated below in FIG. 9B), and/or any other functionality of the robots 102.

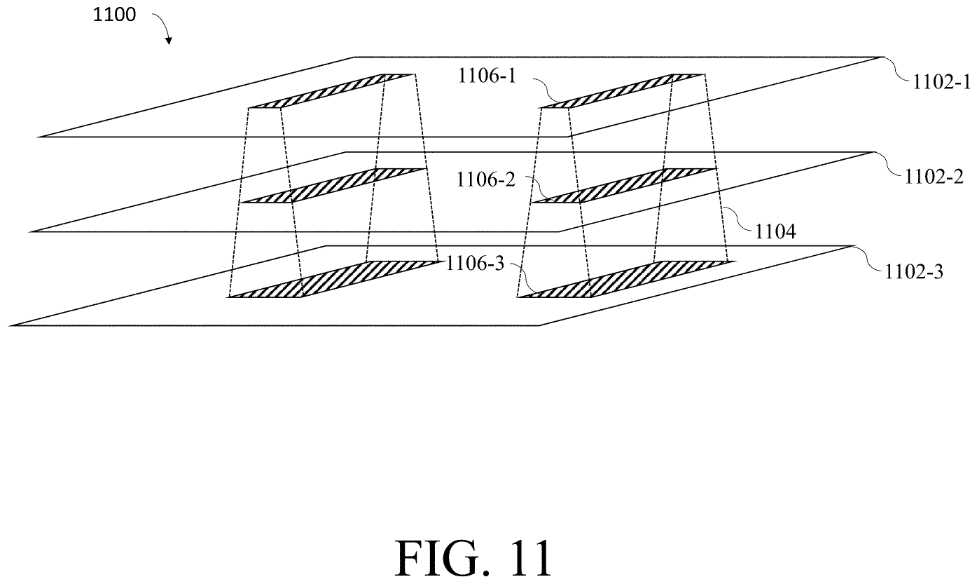

According to at least one non-limiting exemplary embodiment, the N robots 102 on a network may comprise different robots with sensors at different heights. Accordingly, a persistent mapping unit may be further configurable to piece together a persistent map 408 in three dimensions (3D) based on the map data 402-N, received by the individual robots 102-n, comprising map data taken at different heights or elevations (e.g., different floors in a multi-story building), as illustrated below in FIG. 11. According to at least one non-limiting exemplary embodiment, a persistent mapping unit 204 may be further configurable to generate a persistent map 408 of an environmental parameter based on data collected by N robots 102 on a robot network 410 in addition to the localization of objects, as illustrated below in FIG. 9.

According to at least one non-limiting exemplary embodiment, map data 402 may comprise data to be used to update a preexisting persistent map in memory 130 of a cloud server 202. According to at least one non-limiting exemplary embodiment, each of the map data 402 blocks may be illustrative of data collected by one robot 102 at a plurality of different instances in time as the robot 102 navigates through an environment collecting the map data 402.

According to at least one non-limiting exemplary embodiment, the plurality of map data 402 blocks may be collected by a single robot 102 in a training mode, wherein the training mode may comprise a human operator navigating the robot 102 through an environment as the robot 102 collects data to be used to generate the map data 402.

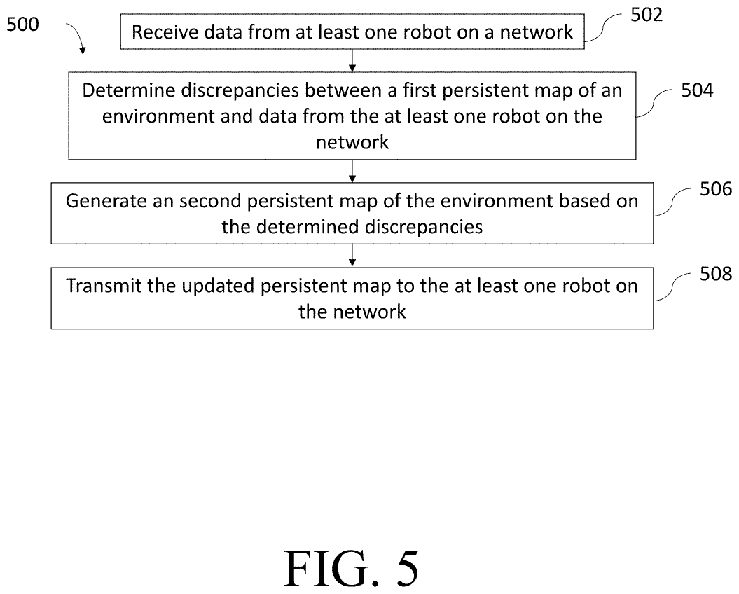

FIG. 5 illustrates a method 500 for a persistent mapping unit 204 of a cloud server 202 to generate a second persistent map of an environment based on data collected by at least one robot 102 on a network, according to an exemplary embodiment. The second persistent map may be a persistent map at a second instance in time of a first persistent map of the environment at a first instance in time.

Block 502 illustrates the persistent mapping unit 204 receiving data from at least one robot 102 on the network. The received data may comprise, for example, data relating to the localization of objects, route data, state parameter data, sensor data, and/or any other type of data of any parameter which may be measured by a robot 102 and communicated to a cloud server 202.

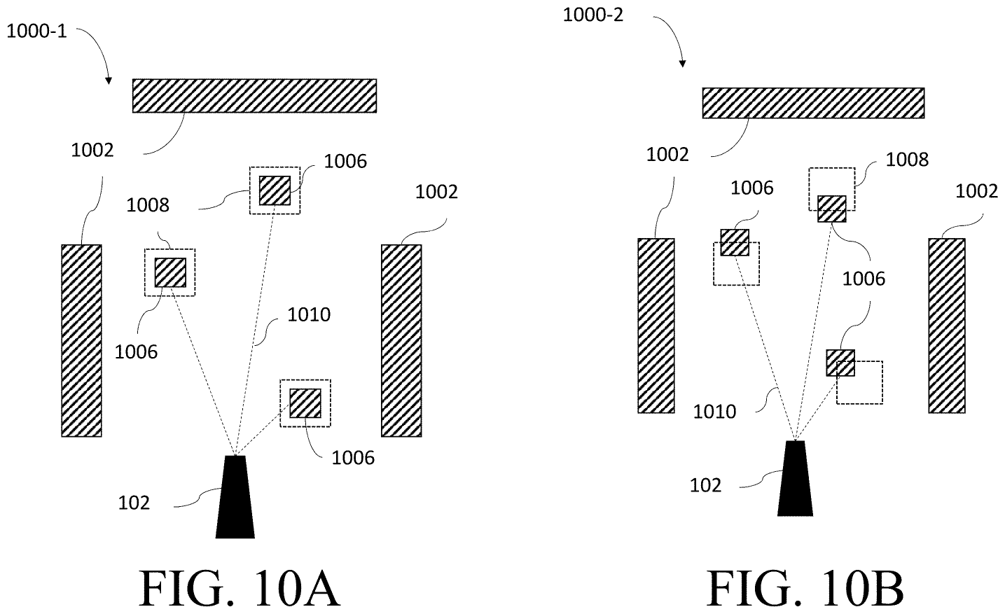

Block 504 illustrates the persistent mapping unit 204 determining discrepancies between a first persistent map of an environment and data collected by the at least one robot 102 on the network. The discrepancies may include, but are not limited to, localization of unmapped objects, changes within an environment not mapped on the first persistent map, and/or any other discrepancy between the received data from the robots 102 and the first persistent map. For example, a robot 102 may detect and localize an object along a route, as illustrated in FIG. 3A-C, not mapped on a first persistent map (e.g., persistent map 300-1), wherein the discrepancy may be a discrepancy between the first persistent map not comprising the detected object and the data comprising the localization of the detected object. The discrepancies may be utilized to determine dynamic and static objects within a persistent map, as illustrated below in FIG. 10A-B. These discrepancies may cause the persistent mapping unit 204 to update the persistent map based on the discrepancies observed by the robots 102 on the network, as illustrated in block 506.

According to at least one non-limiting exemplary embodiment, a first persistent map of an environment may be blank prior to a robot 102 navigating the environment and collecting data from sensor units 114 of the robot 102, wherein discrepancies between the first (blank) persistent map and data collected by the robot 102 may comprise any data collected by the robot 102.

Block 506 illustrates the persistent mapping unit 204 generating a second persistent map based on the determined discrepancies in block 504. The second persistent map may comprise, for example, newly localized objects, changes in positions of objects, and/or changes in parameters of objects or an environment. The second persistent map may comprise a persistent map of the first persistent map at a second instance in time. The discrepancies may be used to determine static and dynamic objects as well as determine if a robot 102 requires calibration to its sensor units 114, as illustrated below in FIG. 10A-B.

Block 508 illustrates the persistent mapping unit 204 utilizing communications unit 206 of the cloud server 202, as illustrated in FIG. 2A, to communicate the second persistent map to the at least one robot 102 on the network. The at least one robot 102 on the network may utilize the second persistent map to, for example, determine and/or accomplish new tasks, accomplish current tasks differently (e.g., based on the changes to the first persistent map), and/or reroute around obstacles detected by other robots 102.

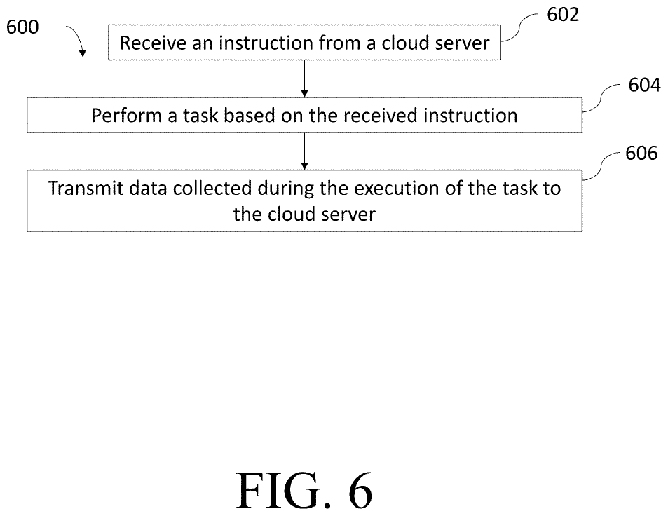

FIG. 6 illustrates a method 600 for a controller 118 of a robot 102 on a network, comprising a plurality of robots 102 communicatively coupled to a cloud server 202, to receive a task and communicate with the cloud server 202, according to an exemplary embodiment. The method 600 may be utilized by a plurality of other robots 102 on the robot network.

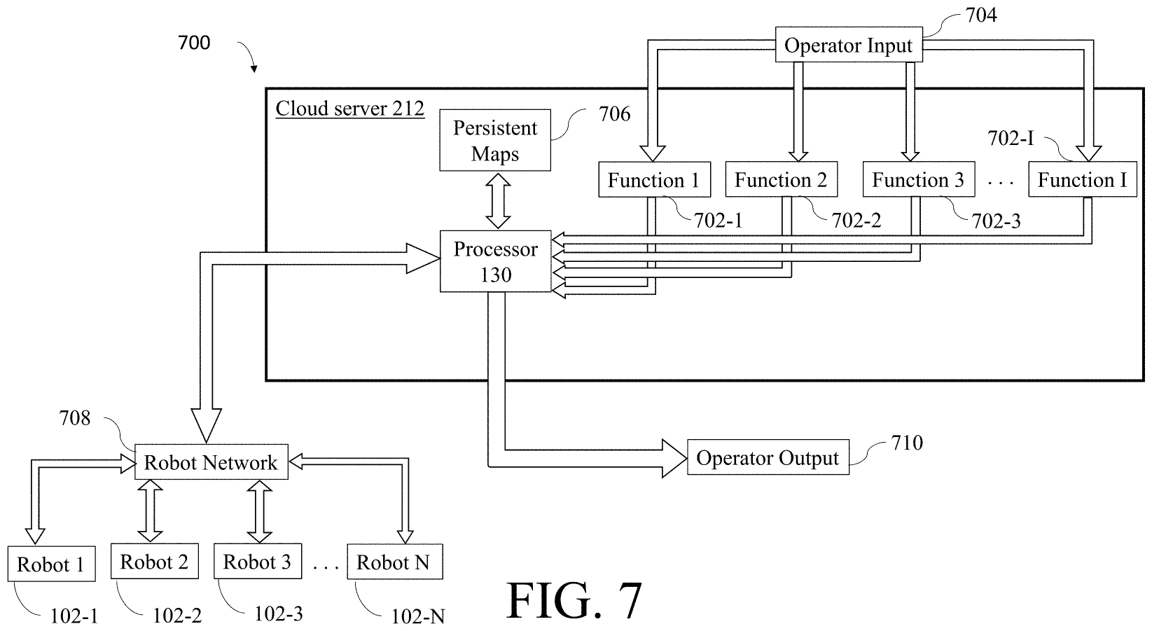

Block 602 illustrates the controller 118 of the robot 102 receiving an instruction from the cloud server 202. The instruction may be transmitted from the cloud server 202 utilizing a transmitter 134 and received by the robot 102 by communications units 116, as illustrated above in FIG. 1A-B. The instruction may comprise a task to be performed by the robot 102. The cloud server 202 may desire to perform a high-level task, wherein the cloud server 202 may abstract the high-level task into a plurality of lower level tasks to be performed, in part, by individual robots 102 on the network, as illustrated in FIG. 7 below.

Block 604 illustrates the controller 118 of the robot 102 performing a task based on the received instruction. The task may comprise a robot 102 navigating to a location, collecting sensor data, detecting objects, and/or other tasks performable by a robot 102.

According to at least one non-limiting exemplary embodiment, the received instruction may comprise a high-level task, wherein the controller 118 of the robot 102 may abstract upon the high-level task to perform a plurality of lower level tasks to accomplish the high-level task of the received instruction. For example, an instruction from a cloud server 202 may include a robot 102 collecting object data of objects at a location on a persistent map of an environment. A controller 118 of the robot 102 may abstract upon the high-level task (e.g., collecting data of the objects) by first navigating the robot 102 to the location of the objects and then collecting the object data requested by the received instruction.

Block 606 illustrates the controller 118 of the robot 102 transmitting data collected during the performed task. The transmitted data may comprise data of which the received instruction requested or data comprising a completion of a task based on the received instruction (e.g., a binary output from the robot 102). The cloud server 202, upon receiving the transmitted data, may, for example, update a persistent map based on the transmitted data or perform operations based on the data (e.g., localization of an object) to respond to a user query, as illustrated below in FIG. 7-8.

FIG. 7 illustrates a functional block diagram of a system 700, wherein the cloud server 212 is configurable to receive an operator input 704; abstract the operator input into a plurality of functions 702-1 to 702-I, the plurality of functions configurable to respond to the operator input 704; utilize a robot network 708 to execute one or more of the plurality of functions 702; and provide an operator output 710, according to an exemplary embodiment. The system 700 may further comprise a cloud server 202 comprising a substantially similar system architecture illustrated above in FIG. 2A and may follow a process flow substantially similar to a method 800 illustrated below in FIG. 8.

The operator input 704 may comprise, for example, an interface unit configurable to receive input from an operator and communicate the input to the cloud server 202. The operator input 704 may comprise a query for data of one or more persistent maps 706 stored in a memory 132 (not shown) of the cloud server 202. The operator input 704 may be abstracted into a plurality of functions to be performed by the cloud server 202 based on the operator input 704. The abstraction of the operator input may be performed by the processing device 130 of the cloud server 202 executing specialized instructions stored in memory 132 (not shown), as illustrated above in FIG. 1B, upon receiving the operator input 704. The operator input 704 may be abstracted into “I” functions, wherein index “I” may be any non-zero integer number of functions of which the operator input 704 may be abstracted into. The processing device 130 of the cloud server 212 may utilize the persistent maps 706 generated previously and/or may communicate with the robot network 708 to generate one or more additional persistent maps or update one or more current persistent maps. The processing device 130 may generate an instruction for the robot network 708 if the robot network 708 is needed to perform one or more of the functions 702 of the operator input 704 (e.g., update or generate a persistent map). In other words, the processing device 130, upon receipt of the one or more of the functions 702-1 to 702-I, which are representative of operator input 704, may then correspond with robot network 708 to accordingly perform one or more of the functions 702-1 to 702-I, and thereafter receive output from the robot network 708.

By way of an illustrative example, an operator may input a request for a cloud server 202 to determine which air conditioning vents in an environment are operating efficiently. To determine which air conditioning vents are operating efficiently, the operator input 704 may be abstracted into a request for a persistent heat map of an environment (function 1), a persistent map of air conditioning vents within the environment (function 2), and a determination by the processing device 130 of the cloud server 202 of which air conditioning vents operate efficiently (function 3) based on data of the two persistent maps.

The robot network 708 may comprise N robots 102, index N being a non-zero integer number, wherein the N robots 102 on the network 708 may comprise a plurality of identical robots 102 or different robots 102 configurable to perform different tasks. The robots 102 on the robot network 708 may be configurable to receive an instruction from the processing device 130 of the cloud server 202 and distribute lower level tasks to the plurality of robots 102 to fulfill the instruction. The lower level tasks may require the robots 102 of the robot network 708 to collect data on a parameter of an environment. The parameters may include, but are not limited to, heat measurements, LTE (long term evolution) signal strength measurements, Wi-Fi signal strength measurement, and/or any other measurement to be collected by the distributed network of robots, wherein the collected measurement data may be used by the robot network 708 to fulfill the instruction from the cloud server 202. Stated another way, the operator input 704 is divided into plurality of functions 702-1 to 702-I, which are received by the processing device 130 in the cloud server 212. The processing device 130, upon receipt of these plurality of functions 702-1 to 702-I, transmits them, at least in part, to a robot network 708 comprising plurality of robots 102-1 to 102-N such that a respective one or more of the plurality of robots 102-1 to 102-N may perform or execute a respective function assigned to it, and accordingly transmit the data collected back to the processing device 130. Each robot 102-1 to 102-N of the network 708 may execute the same, similar, or different movements, measurements, or computer instructions as other robots 102 of the network 708 to acquire the necessary data, which, collectively, may be used to respond to the operator input 704. The processing device 130 thereafter compiles the data received and generates an operator output 710, which may be displayed, e.g., on a graphic user interface for the operator.

Following the above example, wherein a determination of which air conditioning vents are operating efficiently is requested by an operator input 704, the robot network 708 may distribute tasks of mapping and measuring heat distribution data and air conditioning vents designated locations to each of the plurality of robots 102 on the network. The robot network 708, upon fulfillment of the received instruction, may communicate with the processing device 130 of the cloud server 202 any data requested by the received instruction.

The functions of the robot network 708 block, as illustrated, may be performed by the processing device 130 of the cloud server 202, wherein the robot network 708 block as illustrated may be illustrative of the processing device 130 of the cloud server 202 executing computer readable instructions from a memory 132 (not shown) to distribute lower level tasks to a plurality of robots 102 to fulfill an instruction. In other words, the processing device 130 may delegate the lower level tasks to the individual robots 102 on the network 708 required to fulfill an instruction, the instruction being generated based on the plurality of functions 702 to be performed by the robot network 708 in response to the operator input 704.

The processing device 130 of the cloud server 202 may utilize data collected by the robot network 708 to generate or update a plurality of persistent maps 706. The persistent maps 706 may be stored in a memory 132 (not shown) of the cloud server 202, as illustrated above in FIG. 1B, and may be updated based on data received by the robot network 708 during execution of an instruction from the processing device 130. Additional persistent maps 706 may be added to the memory 132 (not shown) based on the operator input 704, such as, for example, when the operator input 704 requests a persistent map of a parameter not already mapped. The processing device 130 may be further configurable to utilize the persistent maps to provide an operator output 710. The operator output 710 may be a response to the operator input 704, such as, following the above example, a determination of which air conditioning vents operate efficiently based on a comparison of the persistent heat map and the persistent air conditioning vent location map. The operator output 710 may be outputted to an external device communicatively coupled to the cloud server 202, such as, for example, a user interface.

According to at least one non-limiting exemplary embodiment, an operator may comprise a robot 102 on a robot network 708 communicatively coupled to a cloud server 202. For example, a robot 102 may input a request for a persistent map of no-go zones, illustrated below in FIG. 9B, such that the robot 102 may determine a route through an environment based on the persistent map of the no-go zones, wherein the operator output 710 may include the output of the persistent map of the no-go zones to the robot 102. One skilled in the art may appreciate the no-go zones to be zones that are not to be traveled by the robot 102.

According to at least one non-limiting exemplary embodiment, the plurality of persistent maps 706 illustrated in FIG. 7 may be stored as a single persistent map comprising data of a plurality of parameters imposed on the single persistent map.

The system 700 illustrates a distributed system of data gathering by a plurality of robots 102 on a robot network 708 based on an instruction received from a cloud server 202, the instruction may be generated based on an operator input 704. The distributed system of data gathering by the plurality of robots 102 on the robot network 708 may enhance the ability of the processing device 130 of the cloud server 202 to generate a plurality of persistent maps 706 simultaneously, rapidly, and in real-time based on the data from the distributed plurality of robots 102. The distributed network of robots 102 may generate the plurality of persistent maps 706 rapidly as mapping data from each individual robot 102 in the robot network 708 may be pieced together to form the plurality of persistent maps 706, as illustrated above in FIG. 4. In addition, the cloud server 202 comprising a plurality of persistent maps 706 stored in a memory 132 (not shown) may increase the number of functions performable on the stored plurality of persistent maps 706, thereby increasing the complexity of an operator input 704, which may be handled by the system 700. The distributed system of gathering inputs may further enable the cloud server 202 to gather useful data from the robot network 708 to update and/or generate one or more persistent maps while simultaneously performing computational operations in real-time on the updated and/or generated persistent maps 706 based on one or more requested functions 702 of an operator input 704.

FIG. 8 illustrates a method 800 for a processing device 130 of a cloud server 202 to receive and process a query from an operator, according to an exemplary embodiment.

Block 802 illustrates the processing device 130 receiving a query from an operator. The query may comprise a request for one or more persistent maps of one or more corresponding parameters (e.g., heat map, LTE signal strength map, etc.) or a request for data based on one or more persistent maps.

Block 804 illustrates the processing device 130 abstracting the query into individual functions, the functions may be lower level abstractions of operations required to respond to the query, as illustrated above in FIG. 7 with respect to an operator input 704 being abstracted into functions 702. These functions may comprise generation of a persistent map, updating a persistent map, and/or operations on one or more persistent maps.

Block 806 illustrates the processing device 130 determining if any of the individual functions, determined in block 804, require persistent map data from at least one robot 102 on a robot network comprising a plurality of robots 102. The cloud server 202 may comprise a plurality of persistent maps stored in a memory 132 generated previously due to, for example, prior queries. However, the query may require the use of a persistent map of a parameter not mapped prior to the query or use of a persistent map requiring updates based on new data collected by the plurality of robots 102.

If the memory 132 does not comprise enough persistent map data to respond to the query, the processing device 130 may move to block 808. In other words, if the processing device 130 determines that the individual functions do require persistent map data from at least one robot on a robot network which is not available to the processing device 130 (e.g., was not measured, is not temporally accurate, etc.), the processing device 130 then moves to block 808, which, in-turn, generates an instruction for the robot network.

If the memory 132 comprises enough persistent map data to respond to the query, the processing device 130 may move to block 812. In other words, if the processing device 130 determines that the individual functions do not require additional persistent map data, and inquiry of the individual functions can be satisfied based on the persistent map data already stored in memory 132, then the processing device 130 simply generates a response to the individual instruction based on the persistent map data present in the memory 132. Therefore, not requiring robot network to generate additional persistent map data as it would have under step 808.

Block 808 illustrates the processing device 130 generating an instruction for the robot network, the instruction may configure the robot network to gather persistent map data using sensor units 114 of one or more robots 102 on the network, the persistent map data may be gathered using the method 600 illustrated above in FIG. 6.

Block 810 illustrates the processing device 130 receiving persistent map data from the robot network, as requested by the instruction generated in block 808. The received persistent map data may comprise updates to existing persistent maps of parameters stored in the memory 132 or may comprise data used to generate one or more new persistent maps of one or more corresponding parameters. The received persistent map data may further comprise persistent map data of one or more parameters at one or more new locations not previously mapped in existing persistent maps stored in memory 132. The processing device 130 may store the received persistent map data in memory 132.

Block 812 illustrates the processing device 130 generating a response to the query based on persistent map data. The response may comprise, for example, one or more persistent maps of one or more parameters, a correlation between two or more persistent maps (e.g., a correlation between a persistent heat map and a persistent air conditioning vent map for determining which air conditioning vent operates efficiently), and/or data from a persistent map of a parameter (e.g., locations of no-go zones for robots on a robot network).

Block 814 illustrates the processing device 130 outputting the response to the operator. The processing device 130 may output the response to a user interface communicatively coupled to the cloud server 202.

According to at least one non-limiting exemplary embodiment, an operator may include a robot 102 providing a query to a cloud server 202. For example, a cleaning robot may query a cloud server 202 to determine locations of floors to clean, wherein the cloud server 202 may utilize the method 800 to respond to the query of the cleaning robot.

FIG. 9A illustrates a persistent heat map 900 of an environment as measured by a heat sensor 906 coupled to a robot 102, according to an exemplary embodiment. A query may be inputted to a cloud server 202 comprising at least one function requiring the persistent heat map 900 of the environment. Accordingly, the cloud server 202 may send an instruction to the robot 102 to collect heat distribution data using the heat sensor 906 to be used by the cloud server 202 to generate the heat map 900 as illustrated in FIG. 9A. The robot 102 may navigate around the environment measuring the heat distribution and communicate such data collected by the heat sensor 906 to a cloud server 202 (not shown). The cloud server 202 may utilize the heat distribution data collected by the robot 102 to generate the persistent heat map 900. The persistent heat map 900 may comprise a plurality of zones 904 comprising varying temperatures. Heat zone 904-1 may correspond to a low temperature, heat zone 904-2 may correspond to a medium temperature, and heat zone 904-3 may correspond to a warm temperature, and so forth. Unmapped heat zones (e.g., areas not within the heat zones 904) may correspond to zones at a reference temperature. Other heat zones (not illustrated) may be observed by the heat sensor 906 of the robot 102, as would be appreciated by one skilled in the art.

According to at least one non-limiting exemplary embodiment, the robot 102 may navigate along routes mapped on a separate persistent route map, similar to the map illustrated above in FIG. 3A-C, wherein the persistent route map may comprise a plurality of routes for the robot 102 to follow while collecting the heat data and avoiding obstacles 902. The persistent route map may be communicated to the robot 102 by the cloud server 202 as part of the instruction.

According to at least one non-limiting exemplary embodiment, heat zone 904-3 may be cooler than heat zone 904-2, and so forth. In other words, the heat map 900 may map zones of low temperature, such as, for example, due to air conditioning vents cooling the air within the respective heat zones 904.

According to at least one non-limiting exemplary embodiment, a plurality of robots 102 equipped with heat sensors 906 may be utilized by a cloud server 202 to collect heat distribution data to be communicated to the cloud server 202 to generate a persistent heat map 900 of an environment.

One skilled in the art would appreciate that the heat sensor 906 as illustrated may be replaced with a plurality of different sensors configurable to measure different parameters of the environment. For example, alternatively, the sensor 906 may be a Wi-Fi sensor configurable to measure Wi-Fi signal strength within the environment, wherein a cloud server 202 may utilize the Wi-Fi signal strength data collected by the sensor 906 to map regions of strong, medium, and weak WiFi signal strength zones.

FIG. 9B illustrates a persistent no-go zone map 908 comprising a plurality of no-go zones 916 and a robot 102 navigating from a start point 910 to an end point 912, according to an exemplary embodiment. No-go zones 916 may comprise regions where navigation of the robot 102 through the no-go zones 916 may be undesirable, thereby causing the robot 102 to reroute a current route if the current route passes through a no-go zone 916. The no-go zones may be determined by, for example, a human operator inputting the location of the no-go zones 916 to a cloud server 202 via a user interface, a robot 102 on a robot network detecting objects blocking passageways between objects 902, and/or one or more CCTV cameras detecting objects or people blocking the passageways between objects 902.

A cloud server 202 may provide the robot 102 with the persistent no-go zone map 908 to enable the robot 102 to navigate around the no-go zones 916 while determining a route 914 from the start point 910 to the end point 912. According to at least one non-limiting exemplary embodiment, route 914 may be determined from the cloud server 202 and communicated to the robot 102.

One skilled in the art would appreciate that the zones 916 may be illustrative of different types of zones other than no-go zones. For example, zones 916 may be illustrative of surfaces of a floor for a cleaning robot 102 to navigate to and clean. These cleaning zones may be determined by the cloud server 202 based on data collected by one or more robots 102, other external devices (e.g., user interfaces, CCTV, etc.), and/or other similar methods.

FIG. 9A and FIG. 9B illustrate two persistent maps 900 and 908, respectively, of the same environment, as illustrated by the objects 902 being at the same locations in both persistent maps 900 and 908. A plurality of other persistent maps may be determined, within the same environment, by a cloud server 202 based on data collected by robots 102 on a robot network coupled to the cloud server 202 and/or data collected by other external devices (e.g., user interfaces, CCTV, etc.). The two persistent maps 900 and 908, as well as other persistent maps of other parameters not illustrated, may be updated in real-time or upon receiving a query from an operator to update or generate a persistent map of a parameter, as illustrated above in FIG. 7. The two persistent maps 900 and 908 illustrated may be persistent maps of the environment at the same instance in time or different instances in time.

FIG. 10A is a persistent map 1000-1 of localization parameters of a plurality of objects 1002 and 1006 at a first instance in time, according to an exemplary embodiment. Objects 1002 may comprise objects previously mapped on the persistent map 1000 at prior instance in time and determined to be stationary obstacles based on their position remaining static in time. Objects 1006 may comprise newly detected objects detected by a robot 102, using sensor units 114 as illustrated by sensor vision lines 1010, not previously mapped onto the persistent map 1000. Accordingly, persistent map 1000-1 at the first instance in time may include the objects 1006.

Processing device 130 of a cloud server 202 may impose movement thresholds 1008 used to determine if the objects 1006 are dynamic or moving objects. The movement thresholds 1008 may be used by the processing device 130 to determine if a respective object is dynamic (i.e., moving object) or non-dynamic (i.e., stationary or static object). A dynamic or moving object may be determined if an object exceeds a movement threshold 1008 imposed around the object within a predetermined period of time, as illustrated next in FIG. 10B. The size of the movement thresholds 1008 may be determined based on the predetermined period of time between the first instance in time and a second instance in time, as illustrated next in FIG. 10B.

FIG. 10B illustrates a persistent map 1000-2 of the environment illustrated above in FIG. 10A at the second instance in time. According to an example embodiment, the persistent map 1000-2 may comprise a persistent map of localization parameters of objects within the environment]. The second instance in time may be of any duration in time later than the first instance in time (e.g., 1 second, 10 seconds, etc.). Movement thresholds 1008 may be positioned at the same location as previously illustrated in the persistent map 1000-1 of FIG. 10A, wherein objects which have moved beyond the movement thresholds 1008 may be determined, by a cloud server 202, to be dynamic or moving objects. The movement of the objects 1006 beyond the movement thresholds 1008 may be observed by the same robot 102 as illustrated in FIG. 10A, as illustrated by sensor vision lines 1010. Alternatively, movement of the objects 1006 beyond the movement thresholds 1008 may be observed by a different robot 102 (not shown in FIG. 10B), wherein the processing device 130 in the cloud server 202 receives the persistent map at first time stamp (i.e., FIG. 10A) and a subsequent persistent map at a second time stamp (i.e., FIG. 10B), and accordingly makes the determination that whether or not certain objects 1006 are in movement.

One skilled in the art would appreciate that the static objects 1002 may have been determined by a cloud server 202 to be static objects using substantially similar methods illustrated in FIG. 10A-B (i.e., based on a movement threshold 1008 around the objects 1002 not being exceeded).

According to at least one non-limiting exemplary embodiment, robots 102 illustrated in FIG. 10A and FIG. 10B may be illustrative of a first and second robot 102 detecting the positions of objects 1006 at a first and second instance in time, respectively. According to at least one non-limiting exemplary embodiment, movement of objects 1006 may be observed by other devices aside from robots 102, such as, for example, CCTV cameras communicatively coupled to a cloud server 202, wherein the cloud server 202 may determine dynamic or static objects based on movements between image frames received by the CCTV cameras.

According to at least one non-limiting exemplary embodiment, a robot 102 may observe an object 1002, known to be a static object, at a different location than previously mapped on persistent map 1000 at prior instances in time. A cloud server 202, communicatively coupled to the robot 102, may determine one or more sensor units 114 of the robot 102 require further calibration as the cloud server 202 may determine, based on observing the object 1002 at the same location at a plurality of prior instances in time, data received by the robot 102 may be generated from uncalibrated sensors (e.g., uncalibrated distance measuring sensors). The cloud server 202 may determine the object 1002 comprises a static object based on their location remaining constant in time (e.g., within 2% error) as observed by a plurality of robots 102 or the same robot 102 at a plurality of prior instances in time. Determining sensor units 114 of a first robot 102 require calibration may further include a cloud server 202 utilizing a second robot 102 to verify the static objects are in the same location, thereby verifying the sensor units 114 of the first robot 102 require calibration.

Advantageously, mapping of dynamic or moving objects may further enhance the ability of a cloud server 202 to effectuate the control of robots 102 coupled to the cloud server 202 by, for example, navigating the robots 102 around or away from the moving objects. Additionally, designating objects as static objects may further enable the cloud server 202 to determine if sensor units 114 of a robot 102, coupled to the cloud server 202, require calibration based on the robot 102 observing a location of the known static object to be at a different location as previously mapped on a persistent map at prior instances in time.

FIG. 11 illustrates a persistent map 1100 in three dimensions (3D), according to an exemplary embodiment. A persistent map may be mapped in 3D using sensor data from multiple robots 102 comprising sensors at different heights or based on a robot 102 comprising multiple sensors at different heights. According to at least one non-limiting exemplary embodiment, a robot 102 may comprise a sensor configurable to collect data in 3D (e.g., an imaging camera) such that a cloud server 202 may utilize the collected sensor data to piece together a 3D persistent map 1100.

The persistent map 1100 may comprise a plurality of layers 1102 at different heights. For example, one or more robots 102 may utilize one or more respective LiDAR sensors to localize surfaces of objects at different heights. Each of the layers 1102 may comprise an object intersection 1106 corresponding to a region occupied by an object at the height of the corresponding layer 1102. As illustrated by dashed lines 1104, the objects intersecting the layers 1102 may comprise a trapezoidal shape; however, any object with a non-zero height may intersect the layers 1102 differently. A cloud server 202 may store the 3D persistent map 1100 as a plurality of layers at set heights comprising object intersections 1106 or may store the 3D persistent map 1100 as a computer assisted design (CAD) model of an environment in memory 132 of the cloud server 202. That is, two dimensional measurements (e.g., from LiDAR sensors) collected by one or more sensor units 114 may be composited to generate a three dimensional model of an object.

According to at least one non-limiting exemplary embodiment, a 3D (three-dimension) persistent map 1100 may be a persistent map of a parameter other than the localization of objects as illustrated. For example, the persistent heat map 900 illustrated above in FIG. 9A may be only a cross section (e.g., a plane of reference such as planes 1102) of a 3D persistent heat map, wherein the heat distributions measured by a robot 102 may be mapped in 3D.

Advantageously, generation of a 3D persistent map 1100 may enhance the ability for different robots 102 of different heights to operate within the same environment using the same 3D persistent map 1100. According to at least one non-limiting exemplary embodiment, a cloud server may distribute a 3D persistent map 1100 to a robot 102 which may be configurable to collect sensor data of objects below a certain height, wherein the 3D persistent map 1100 passed to the robot 102 may not comprise mapped objects above the height of which the robot 102 can observe with its sensor units 114. Passing a 3D persistent map 1100 cut off at a height may save space in memory 120 of the robot 102 as the robot 102 may not need 3D map data above the height of which the robot 102 can observe.

One skilled in the art would appreciate that any of the persistent maps illustrated in the above figures (e.g., persistent maps 300, 900, 908, and 1000) may comprise 3D persistent maps of a corresponding parameter, wherein the persistent maps illustrated may be illustrative of a single layer of the persistent maps.

According to example embodiments disclosed herein, they are directed to systems, methods and non-transitory computer readable media wherein at least one processing device is configurable to execute computer readable instructions to generate a map of a parameter corresponding to an environment based on data collected by a respective device of a plurality of devices, the map being generated based on measurements of the parameter using a sensor coupled to the respective device and a position of the respective device, the measurements occurring at a first time instance; determine whether to update the map based on data transmitted by the respective device during a second time instance; and update the map to incorporate the data transmitted during the second time instance if the data transmitted during the second time instance includes information not incorporated in the map during the first time instance.

Further, the at least one processing device is configurable to execute the computer readable instructions to determine at least one object in the environment to be either a dynamic object or a static object based on discrepancies between the map at the first time instance and the map at the second time instance, the dynamic object is determined based on a predetermined movement threshold; and update the map at a later time instance to include the dynamic and static objects. And, determine the at least one object is a dynamic object if the at least one object exceeds a movement threshold imposed around the at least one object within a predetermined period of time; and determine if at least one sensor on the respective device requires calibration based on the respective device detecting the static object at a location different from a location on the map at the second time instance.

The systems, methods, and non-transitory computer readable media of example embodiments according to this disclosure require at least one processing device configurable to execute the computer readable instructions to receive a query from an operator, the query comprising a request for the data received at the first and second time instances, and respond to the query based on the data collected by the plurality of devices during the first and second time instances, the plurality of devices corresponds to a network of plurality of robots. And, further receive at least one instruction from the operator for the plurality of robots, the instruction including individual tasks to be executed by each one of a respective robot in the network of the plurality of roots in the environment.

It will be recognized that, while certain aspects of the disclosure are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting.

As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term ‘includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein, “defined” or “determined” may include “predefined” or “predetermined” and/or otherwise determined values, conditions, thresholds, measurements, and the like.

What is claimed is:

1. A non-transitory computer readable storage medium having computer readable instructions stored thereon, that when executed by at least one controller, configure the at least controller to,
generate a map of a parameter corresponding to an environment based on data collected by a respective device of a plurality of devices, the map being generated based on measurements of the parameter using a sensor coupled to the respective device and a position of the respective device, the measurements occurring at a first time instance;
determine whether to update the map based on data transmitted by the respective device during a second time instance; and
update the map to incorporate the data transmitted during the second time instance if the data transmitted during the second time instance includes information not incorporated in the map during the first time instance.

2. The non-transitory computer readable storage medium of claim 1, wherein the at least one controller is further configured to execute the computer readable instructions to,
determine at least one object in the environment to be either a dynamic object or a static object based on discrepancies between the map at the first time instance and the map at the second time instance, the dynamic object is determined based on a predetermined movement threshold; and
update the map at a later time instance to include the dynamic and static objects.

3. The non-transitory computer readable storage medium of claim 2, wherein the at least one controller is further configured to execute the computer readable instructions to,
determine the at least one object is dynamic object if the at least one object exceeds a movement threshold imposed around the at least one object within a predetermined period of time.

4. The non-transitory computer readable storage medium of claim 2, wherein the at least one controller is further configured to execute the computer readable instructions to,
determine if at least one sensor on the respective device requires calibration based on the respective device detecting the static object at a location different from a location on the map at the second time instance.

5. The non-transitory computer readable storage medium of claim 1, wherein the at least one controller is further configured to execute the computer readable instructions to,
receive a query from an operator, the query comprising a request for the data received at the first and second time instances, and
respond to the query based on the data collected by the plurality of devices during the first and second time instances, the plurality of devices corresponds to a network of plurality of robots.

6. The non-transitory computer readable storage medium of claim 5, wherein the at least one controller is further configured to execute the computer readable instructions to,
receive at least one instruction from the operator for the plurality of robots, the instruction comprises individual tasks to be executed by each one of a respective robot in the network of the plurality of roots in the environment.

7. A system including a plurality of robots communicatively coupled to a server, comprising:
a controller configured to execute computer readable instructions to,
generate a map of a parameter corresponding to an environment based on data collected by a respective robot of the plurality of robots, the map being generated based on measurements of the parameter using a sensor coupled to the respective robot and a position of the respective robot, the measurements occurring at a first time instance;
determine whether to update the map based on data transmitted by the respective robot during a second time instance; and
update the map to incorporate the data transmitted during the second time instance if the data transmitted during the second time instance includes information not incorporated in the map during the first time instance.

8. The system of claim 7, wherein the controller is further configured to execute the computer readable instructions to,
receive a query from an operator, the query comprising a request for the data received at the first and second time instances; and
respond to the query based on the data collected by the plurality of robots during the first and second time instances.

9. The system of claim 8, wherein the controller is further configured to execute the computer readable instructions to,
receive at least one instruction from the operator for the plurality of robots, the instruction including individual tasks to be executed by each one of the respective robot of the plurality of roots.

10. The system of claim 7, wherein the controller is further configured to execute the computer readable instructions to,
determine at least one object in the environment to be either a dynamic object or a static object based on discrepancies between the map at the first time instance and the map at the second time instance, the dynamic object is determined based on a predetermined movement threshold; and
update the map at a later time instance to include the dynamic and static objects

11. The system of claim 10, wherein the controller is further configured to execute the computer readable instructions to,
determine the at least one object is dynamic object if the at least one object exceeds a movement threshold imposed around the at least one object within a predetermined period of time.

12. The system of claim 10, wherein the controller is further configured to execute the computer readable instructions to,
determine if at least one sensor on the respective robot require calibration based on the respective robot detecting the static object at a location differing from a location on the map at the second time instance.

13. A method for communicatively coupling a plurality of robots in an environment, the method comprising:
generate a map of a parameter corresponding to an environment based on data collected by a respective robot of a plurality of robots, the map being generated based on measurements of the parameter using a sensor coupled to the respective robot and a position of the respective robot, the measurements occurring at a first time instance;
determining whether to update the map based on data transmitted by the respective robot during a second time instance; and
updating the map to incorporate the data transmitted during the second time instance only if the data transmitted during the second time instance includes information not incorporated in the map during the first time instance.

14. The method of claim 13, further comprising:
receive a query from an operator, the query comprising a request for the data received at the first and second time instances,
responding to the query based on the data collected by the plurality of robots during the first and second time instances.

15. The method of claim 13, further comprising:
receiving at least one instruction from the operator for the plurality of robots, the instruction including individual tasks to be executed by each one of the respective robot of the plurality of roots.

16. The method of claim 13, further comprising:
determining at least one object in the environment to be either a dynamic object or a static object based on discrepancies between the map at the first time instance and the map at the second time instance, the dynamic object is determined based on a predetermined movement threshold; and
updating the map at a later time instance to include the dynamic and static objects.

17. The method of claim 16, further comprising:
determining the at least one object is dynamic object if the at least one object exceeds a movement threshold imposed around the at least one object within a predetermined period of time.

18. The method of claim 16, further comprising:
determining if at least one sensor on the respective device require calibration based on the respective device detecting the static object at a location differing from a location on the map at the second time instance.

19. The method of claim 13, further comprising:
receiving at least one instruction from a server, the instruction comprising data collected by the respective robot;
performing a task based on the data collected by the respective robot; and
responding to the at least one instruction from the server, the response comprising the data collected by the respective robot during execution of the task.
